(19) United States
(12) Patent Application Publication
(10) Pub. No.: US 2017/0255865 A1
(43) Pub. Date: Sep. 7, 2017

(54) COMPUTER APPLICATION ACTION EXPERIMENTATION

(71) Applicant: Microsoft Technology Licensing, LLC, Redmond, WA (US)

(72) Inventors: Vlad Riscutia, Redmond, WA (US); Priya Vaidyanathan, Clyde Hill, WA (US); Darron J. Stepanich, Seattle, WA (US); Scott Hoogerwerf, Seattle, WA (US)

(73) Assignee: Microsoft Technology Licensing, LLC, Redmond, WA (US)

(21) Appl. No.: 15/057,331

(22) Filed: Mar. 1, 2016

(51) Int. Cl. G06N 5/04; H04L 29/08

(52) U.S. Cl. CPC G06N 5/046; H04L 67/306; H04L 67/22

(57) ABSTRACT

Experimentation action definitions can each define a different computer action. Execution rules can govern an execution order of the different computer actions. A set of computer-readable preference levels of a current user profile can be received. Each of the preference levels can be for a corresponding one of the executed actions being executed for the current user profile. The preference levels can correspond to user interface responses to the execution of the executed actions. One of the executed actions can be selected as a follow-up action to take for a subsequent user profile. The selecting can include selecting the follow-up action from among a plurality of available actions such as the executed actions. In response to the selection, execution of the selected follow-up action for a subsequent user profile can be requested.

### BACKGROUND

Computer systems can be personalized to a particular user and/or a particular use scenario. For example, computer systems may receive user input to revise computer application settings. In some applications, a set of hard coded rules may allow a system to adapt to a small set of computer use scenarios. Some automated personalization of computer systems has also been performed in different applications and services, such as in the area of content searching and providing of digital advertisements, where many factors are combined in a ranking system to rank and display content such as advertisements or search results.

### SUMMARY

The tools and techniques discussed herein relate to computer system experimentation on computer actions to be taken by computer applications.

As an example, the tools and techniques can include storing experimentation action definitions in a computer system. Each of the definitions can define a different computer action. Execution rules can also be stored in the computer system, where the execution rules can govern an execution order of the different computer actions. A set of computer-readable preference level(s) of a current user profile can be received. Each of the preference level(s) can be for a corresponding one of the executed actions being executed for the current user profile. The preference levels can correspond to user interface responses to the execution of the executed actions.

The example of the tools and techniques can further include selecting one of the executed actions as a follow-up action to take in the computer system for a subsequent user profile. This selecting can include applying a set of computer-readable selection rules (which may or may not be combined with the execution rules) to at least one of the one or more preference levels. The selecting can also include accounting for common characteristic(s) between the subsequent user profile and the current user profile. The selecting can include selecting the follow-up action from among a plurality of available actions. In response to the selection, execution of the selected follow-up action for a subsequent user profile can be requested.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described aspects may be implemented.

FIG. 2 is a block diagram of a computer action experimentation system.

FIG. 3 is a schematic diagram of a client-server example of a computer action experimentation system.

FIG. 4 is a flowchart of a computer action experimentation technique.

FIG. 5 is a flowchart of another computer action experimentation technique.

### DETAILED DESCRIPTION

Aspects described herein are directed to techniques and tools for computer system experimentation with computer actions, which can result in one or more benefits such as efficient selection of a computer action that is personalized to a particular user profile or group of user profiles. Such experimentation and/or selection may involve or result from the use of various techniques and tools separately or in combination.

Such techniques and tools may include a computer system that is configured to react in real-time to user profile responses to computer system actions, such as actions taken in related applications. As used herein, an action being performed for a user profile or by a user profile (such as an action being taken for a user profile or a user profile responding to an action), or similar language relative to acts or actions taken by or for a user profile refers to the action being performed in a computing environment where the user profile is active. For example, an action may be performed by or for a user profile where the action is performed by or at the request of a computer device where the user profile is actively logged in on the computer or on a remote computer in a session that is being actively conducted with the computer device. For example, the user profile may be actively logged in on the computer device, or actively logged into a Website with which a client computer device is actively communicating. The reaction of the computer system may also consider other data stored in the computer system that represents information about a user profile for whom a computer system follow-up action is to be taken, and the computer system may also consider external factors that are not directly related to the user profile.

The computer application actions discussed herein can be any of various different actions taken by computer applications that can result in presentations on user interface devices, so that responsive user input can be received in response to the action being taken by the computer application. For example, the actions may be defined by particular settings that trigger different modes of operation within an application that control some action to be taken by the computer application, or by some other action definition that is outside the computer application. For example, an action may be a particular way of presenting a new feature of an application, such as in a particular menu or on a particular screen view that is presented by the application. As another example, an action may be a version of a new feature, so that different actions that are options for experimentation include multiple different versions of the new application feature. As yet another example, an action may be a suggestion to use a different application, and the different actions may be different suggestions (such as multiple different types of enticements to use the different application) and/or different ways of presenting the same suggestion.

The computer system can perform a set of computer actions, monitor responses to the set of computer actions by a set of one or more user profiles, and dynamically take a follow-up action based on the responses by that user profile set. For example, the computer system may automatically select such a follow-up action based on stored data that represents the responses by the user profile set. This series of experimenting with a set of actions, and using the response of the user profile to select a follow-up action may be repeated a single time or multiple times. For example, the selected follow-up action may be part of a set of multiple actions that can be experimented upon, so that the user interface responses to performing those actions can be considered in selecting yet another follow up action. This repeating series of experimenting can be performed for a single user profile, or it may be performed for a group of user profiles, and responses from the group can be aggregated to find a highest scoring action for that group of users, based on the user profile responses to the actions. Accordingly, as such experimentation is repeatedly performed, machine learning can occur and the computer system itself can be improved as the computer system is able to utilize additional data inputs in performing dynamic selection of subsequent actions to be taken in the computer system. For example, the computer system's dynamic selection of actions can take into account responses to actions from multiple previous iterations of actions and responses, possibly from multiple different sets of user profiles.

Thus, the computer system may provide dynamic or automated decision-making in applications based on responses from one or more user profiles across one or more computer system endpoints, such as client computer devices. Accordingly, the tools and techniques can improve the computer system by making the computer system more efficient and more usable for computer system users. For example, by automatically analyzing available data from user responses to previous actions, the system can perform a personalized action for a subsequent user profile without having to receive and respond to a series of user inputs that would normally be performed for a user profile to instruct the computer system to provide that same action. Thus, the use of computer resources associated with that series of user inputs can be avoided. In addition to being more efficient, the computer system can be more usable because such actions can be provided without a user of the subsequent user profile having to expend time and energy to provide a series of instructions to the computer system to in an effort to get the computer system to perform the personalized action. Additionally, the use of software developers' time and associated computer resources may be decreased by automatically choosing actions based on rule sets defined by software developers, rather than utilizing resources by having software developers provide manual user input to adjust actions based on changes in user profiles over time.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

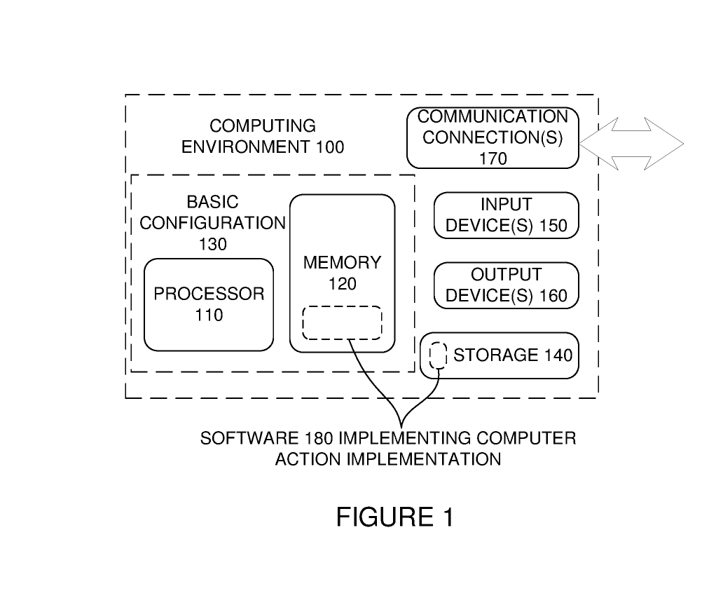

Techniques described herein may be used with one or more of the systems described herein and/or with one or more other systems. For example, the various procedures described herein may be implemented with hardware or software, or a combination of both. For example, the processor, memory, storage, output device(s), input device(s), and/or communication connections discussed below with reference to FIG. 1 can each be at least a portion of one or more hardware components. Dedicated hardware logic components can be constructed to implement at least a portion of one or more of the techniques described herein. For example and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

FIG. 1 illustrates a generalized example of a suitable computing environment 100 in which one or more of the described aspects may be implemented. For example, one or more such computing environments can be used as a server computer and/or client computer in a client-server system, as a peer computer in a peer-to-peer network computer system, and/or or a stand-alone computer in a stand-alone computer system. Generally, various different computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment 100 is not intended to suggest any limitation as to scope of use or functionality of the invention, as the present invention may be implemented in diverse types of computing environments.

With reference to FIG. 1, various illustrated hardware-based computer components will be discussed. As will be discussed, these hardware components may store and/or execute software. The computing environment 100 includes at least one processing unit or processor 110 and memory 120. In FIG. 1, this most basic configuration 130 is included within a dashed line. The processing unit 110 executes computer-executable instructions and may be a real or a virtual processor. In a multi-processing system, multiple processing units execute computer-executable instructions to increase processing power. The memory 120 may be volatile memory (e.g., registers, cache, RAM), non-volatile memory (e.g., ROM, EEPROM, flash memory), or some combination of the two. The memory 120 stores software 180 implementing computer action experimentation. An implementation of computer action experimentation may involve all or part of the activities of the processor 110 and memory 120 being embodied in hardware logic as an alternative to or in addition to the software 180.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more aspects of the technology discussed herein. Distinction is not made between such categories as “workstation,” “server,” “laptop,” “handheld device,” etc., as all are contemplated within the scope of FIG. 1 and reference to “computer,” “computing environment,” or “computing device.”

A computing environment 100 may have additional features. In FIG. 1, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The memory 120 can include storage 140 (though they are depicted separately in FIG. 1 for convenience), which may be removable or non-removable, and may include computer-readable storage media such as flash drives, magnetic disks, magnetic tapes or cassettes, CD-ROMs, CD-RWs, DVDs, which can be used to store information and which can be accessed within the computing environment 100. The storage 140 stores instructions for the software 180.

The input device(s) 150 may be one or more of various different input devices. For example, the input device(s) 150 may include a user device such as a mouse, keyboard, trackball, etc. The input device(s) 150 may implement one or more natural user interface techniques, such as speech recognition, touch and stylus recognition, recognition of gestures in contact with the input device(s) 150 and adjacent to the input device(s) 150, recognition of air gestures, head and eye tracking, voice and speech recognition, sensing user brain activity (e.g., using EEG and related methods), and machine intelligence (e.g., using machine intelligence to understand user intentions and goals). As other examples, the input device(s) 150 may include a scanning device; a network adapter; a CD/DVD reader; or another device that provides input to the computing environment 100. The output device(s) 160 may be a display, printer, speaker, CD/DVD-writer, network adapter, or another device that provides output from the computing environment 100. The input device(s) 150 and output device(s) 160 may be incorporated in a single system or device, such as a touch screen or a virtual reality system.

The communication connection(s) 170 enable communication over a communication medium to another computing entity. Additionally, functionality of the components of the computing environment 100 may be implemented in a single computing machine or in multiple computing machines that are able to communicate over communication connections. Thus, the computing environment 100 may operate in a networked environment using logical connections to one or more remote computing devices, such as a handheld computing device, a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment 100, computer-readable storage media include memory 120, storage 140, and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various aspects. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Computer Action Experimentation System

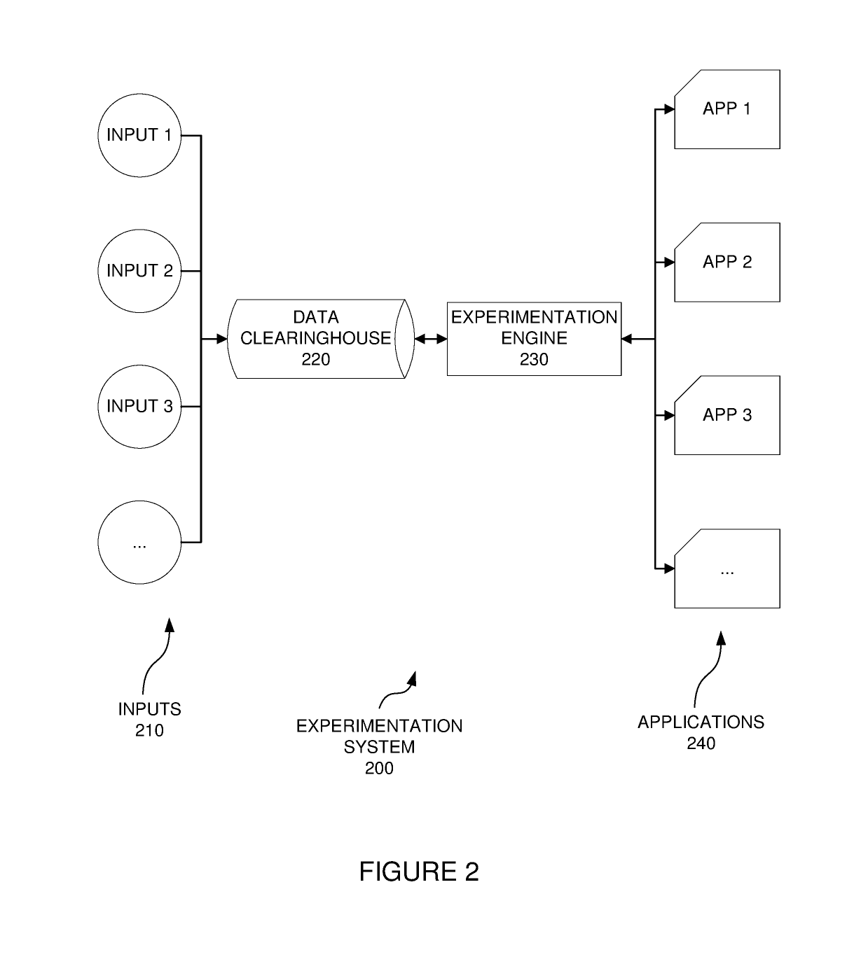

Referring now to FIG. 2, components of a computer action experimentation system 200 are discussed. The system 200 can include components that can be distributed in various ways among multiple different computing devices, or the components may be included in a single computing device. The components can include data inputs 210 that can be computer-readable data that is stored in a data clearinghouse 220. In addition to the data inputs 210 and the data clearinghouse 220, the components can include an experimentation engine 230, and applications 240. Each of these components is discussed below.

Each of the components includes hardware, and may also include software. For example, a component of FIG. 2 can be implemented entirely in computer hardware, such as in a system on a chip configuration. Alternatively, a component can be implemented in computer hardware that is configured according to computer software and running the computer software. The components can be distributed across computing machines or grouped into a single computing machine in various different ways. For example, a single component may be distributed across multiple different computing machines (e.g., with some of the operations of the component being performed on one or more client computing devices and other operations of the component being performed on one or more machines of a server).

The data clearinghouse 220 may take any of various forms, such as computer hardware hosting a single database or multiple databases. The data clearinghouse 220 can store the data inputs 210 according to one or more schemas that can be utilized by other components of the experimentation system 200 to submit data to, manage data in, and read data from the data clearinghouse 220.

The computer-readable data inputs 210 can be accessed and used by other components in the system 200 to perform experimentation operations as discussed herein. Accordingly, the data inputs 210 may be said to “seed” the experimentation operations of the system 200. These data inputs 210 can include various types of data, such as data representing external pieces of information (e.g. data regarding a user profile's calendar, or a traffic incident on the route home for a user of a user profile), internal content provided by the system (such as a new computer service offer, an option to upgrade to a newer computer software application version, a content for a new digital advertisement, or what type of end user client device is being used), and the result of actions taken by an application 240 itself (experiment results indicating user behavior as detected from user input data). The data inputs 210 can also include inputs representing usage of other applications 240 by the user profile for which selections are being made, whether or not that application is configured to perform actions selected by the experimentation engine 230. For example, the data inputs 210 can indicate what the user profile has searched using a different application 240. As another example, the data inputs 210 can indicate the amount of time the user profile has spent using different applications, and/or particular features of one or more applications. As another example, data inputs 210 can include inputs from related user profiles. For example, if a user's social networking profile is linked to the user's work computer network profile, then characteristics of the social networking profile's use of a social network may be considered in selecting actions for the computer network profile. Various different combinations of such data inputs 210 and/or other data inputs 210 can be utilized as factors by the experimentation engine 230 in selecting actions as follow-up actions.

The experimentation engine 230 can include an experimentation platform and a rules engine, and settings or features of the configuration of the experimentation engine 230 can also be data inputs 210 to the experimentation system 200. With the data clearinghouse 220 storing data inputs 210, the experimentation engine 230 can use that information to provide instructions to the applications 240 of what actions to take, and possibly when or how to take those actions.

For example, the experimentation engine 230 may send data to an application 240 running on a mobile computing device, instructing the application 240 to present a particular software tool when the application 240 detects from GPS data that the mobile computing device is traveling on a route to a location that is designated as a “home” location for an active user profile on the mobile computing device. Based on the user profile's response to the application 240 presenting the tool, the experimentation engine 230 can dynamically evaluate the success or failure of showing the tool and dynamically change content, audience, etc. to make the showing more effective.

For example, if the application is a voice-driven digital assistant application, the tool is a tool to provide content during a drive home from work, and the user responds to the presentation of the tool by confirming the tool, the showing of the tool can be considered a success. For example, if the tool presents a voice prompt asking, “Shall I start voice navigation to Home?,” and the application 240 detects a user voice input recognized as “Yes”, then the voice navigation can be started, and this result can be provided to the experimentation engine 230, which can recognize the presentation of the voice prompt as successful. On the other hand, if the application 240 detects a user voice input recognized as “No”, then the voice navigation may not be started, and this result can be provided to the experimentation engine 230, which can recognize the presentation of the voice prompt as unsuccessful.

In this example, the next time the application 240 detects from GPS data that the mobile computing device is traveling on a route to a location that is designated as a “home” location for an active user profile on a mobile computing device, the application 240 may attempt a different option. For example, the application 240 (maybe the same application that presented the first voice prompt, or a different application) can present a voice prompt asking, “Shall I start the ‘My Favorite Music’ playlist?” The system 200 can respond to this prompt in a manner similar to the first voice prompt. Based on the user profile response to these voice prompts, and possibly other voice prompts on the route to “home” on different occasions, the experimentation engine can score the different voice prompts to calculate a highest scoring voice prompt. That highest scoring voice prompt may be used as a follow-up action for future instances when the system 200 detects that the mobile device with the active user profile is on the route home.

Likewise, the experimentation engine can score the success ratings from presenting these voice prompts for other user profiles, and can consider scores for groups of user profiles with similar characteristics. For example, stored data for the user profiles may each indicate a profession of the corresponding user, and the home and work locations for the corresponding user. The experimentation engine 230 may calculate that 85 percent of engineers working in a particular large metropolitan area would rather have voice navigation while driving on the route home than listening to a playlist on the route home. On the other hand, the experimentation engine 230 may calculate that 92 percent of nurses working in a particular smaller metropolitan area would rather listen to a “My Favorite Music” playlist on the route home from work than to have voice navigation. Accordingly, the experimentation engine 230 can consider such group statistical data, as well as data indicating a particular user profile's past responses to related actions, in calculating which action to take for a particular user.

The experimentation engine 230 may also take additional external factors into consideration. For example, in scoring the music playlist suggestion versus the voice navigation suggestion, the experimentation engine 230 may take into account additional data inputs 210 that are not user profile responses to previous related computer actions. For example, the expected traffic delay and/or the expected weather at this time on the usual route from the user profile's work location to the user profile's home location may be considered as a factor. Such weather and traffic information may be provided to the data clearinghouse 220 as data inputs 210, such as from remote weather forecasting and traffic reporting computer services. The data clearinghouse 220, the experimentation engine 230, and/or the application 240 may passively receive or actively retrieve such information to be used in scoring different action options.

In comparing and scoring different computer action options, the experimentation engine 230 can consider the user profile responses to previous similar actions such as where factors were similar. For example, if sufficient response data is not available with all considered factors aligning with a current situation (e.g., where a lawyer in City A is on the route from work to home with light rain and a 17 percent delay due to traffic), then the scoring may combine response results with the different factors. For example, the combining of results may include summing, averaging, applying other operations such as logarithms, applying weights to success rates for different factors (e.g., applying one weight to a success rate for all lawyers, and another weight for a success rate for drives during light rain), and/or other operations for combining different factors in computerized selection or scoring processes. Using the resulting scores, the experimentation engine 230 of the experimentation system 200 may order the computer actions from highest score to lowest score, and may communication a resulting order of actions to an application 240, so that application 240 can respond by performing the actions in the prescribed order (such as from highest score to lowest score), or possibly only performing some of the actions in that order starting with the highest scoring action until receiving a positive user input response to one of the actions so that action is determined to be successful for a user profile. The application 240 can then repeat the successful action for that user profile.

In other implementations, the operation of the experimentation engine 230 may be more simplistic. For example, there may be a set of multiple actions to be experimented upon. The system 200 can present the actions in series until user input indicates success for one of the actions, or until all the actions have been performed. If user input indicates success for an action, that successful action may be used from that point forward, and the other actions may be avoided in response to indication of success. If all the actions are tried without success, then the different actions may be continued to be repeated in series. At some point (such as after all options have been tried a specified number of times), the actions may be ceased altogether if no actions are confirmed as successful by user input.

The experimentation engine 230 may also deliver messages to and receive messages from the applications 240. The applications 240 may be applications installed on end user computer devices and/or applications operating remotely, such as Web applications. Indeed, a single application may include a portion operating locally on an end user device, and another portion operating remotely as a service. The applications 240 can perform actions for user profiles, such as by presenting content on user interface devices, and can receive user input for the user profiles user interface devices. Each application 240 can operate autonomously, and can use the experimentation engine 230 to instruct the application 240 on what content to present, when to present that content, and/or how to present that content for user profiles, as discussed herein. Each application can also send preference levels (indications of user behavior or the success or failure of an experiment based on user input in response to one or more actions being executed) back to the experimentation engine 230, so that the experimentation engine 230 can use the outcome of the experiment to affect selection of actions in the future.

The components in FIG. 2 and elsewhere in the application may be configured in different ways. For example, some or all of the functionality of the experimentation engine 230 may be coded into each computer application 240, some functionality of the data clearinghouse 220 may be performed by the experimentation engine 230, etc.

### III. Example Client-Server Computer Application Action Experimentation System

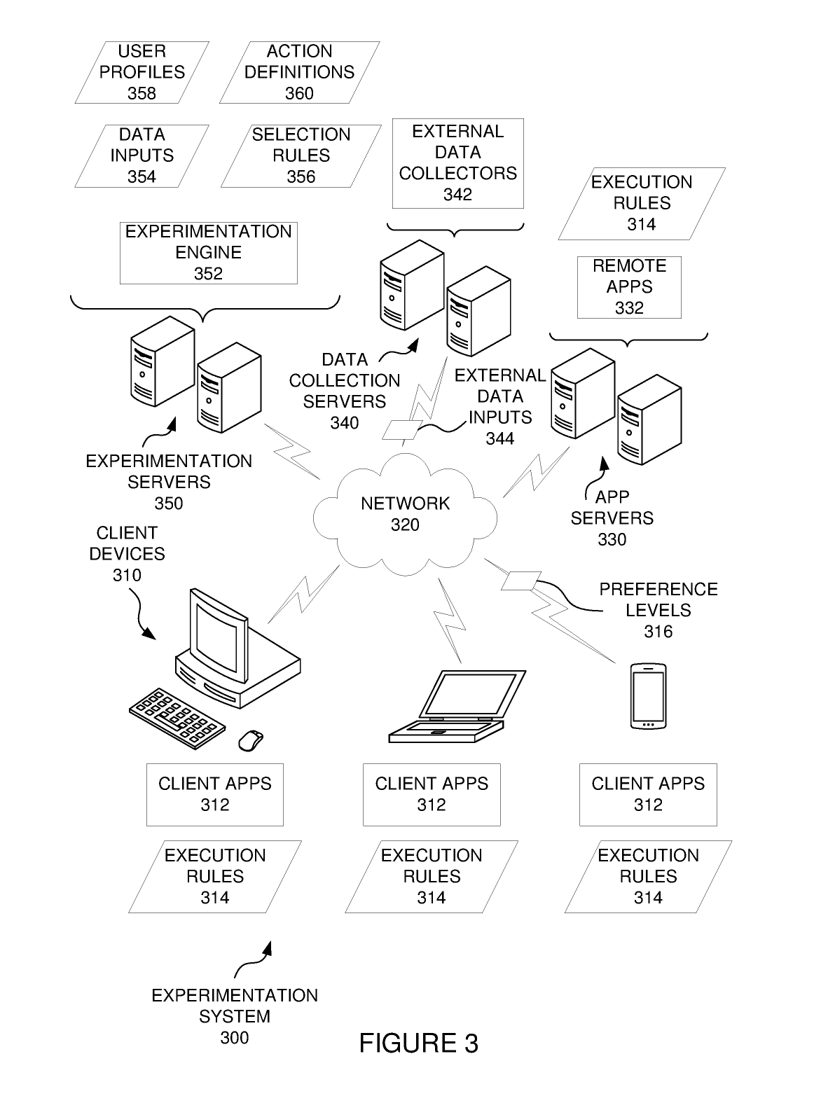

An example experimentation system 300 in a particular client-server environment will now be discussed with reference to FIG. 3. As discussed above, other configurations are also possible, and this particular configuration should not be construed as limiting the claims herein.

Communications between the various devices and components discussed herein can be sent using computer system hardware, such as hardware within a single computing device, hardware in multiple computing devices, and/or computer network hardware. A communication or data item may be considered to be sent to a destination by a component if that component passes the communication or data item to the system in a manner that directs the system to route the item or communication to the destination, such as by including an appropriate identifier or address associated with the destination. Also, a data item may be sent in multiple ways, such as by directly sending the item or by sending a notification that includes an address or pointer for use by the receiver to access the data item. In addition, multiple requests may be sent by sending a single request that requests performance of multiple tasks. A network can include a plurality of private and/or public interconnected networks and can include one or more of various types of computer networks that can be configured to work together. The messages sent over such networks or through individual computer components can use one or more existing protocols and computer languages, such as TCP/IP, HTML, etc.

The experimentation system 300 can include client devices 310, which can each host a client application 312 and execution rules 314 (which may or may not be included in the client application 312 itself). Alternatively, the execution rules 314 may be located elsewhere in the experimentation system 300. The execution rules 314 can dictate how and when to execute different actions using the client applications 312. For example, the execution rules 314 may dictate an order for executing each action in a set of actions in series. For example, the execution rules 314 may dictate that action A is to be taken first, then action B, then action C. The rules for the order of the actions may be more complex, such as where the order of subsequent actions to be taken depends on user profile preference responses to previous actions. Accordingly, the execution rules 314 may include some selection features, and indeed may even function as selection rules, which are discussed more below. For example, the execution rules 314 may dictate that if action A is successful, then take action B, but if action A is unsuccessful, then take action C, or the execution rules 314 may dictate that if action A is successful, then repeat action A instead of executing the other actions in the experiment.

The client devices 310 can be connected to other computer devices through the network 320. Application servers 330 may also be connected to the network 320. For example, the application servers 330 may provide remote applications 332, such as Web applications. The remote applications 332 may function together with the client applications 312, such as where the client applications 312 include Web browser applications or other applications that are configured to work together with the remote applications 332. The application servers 330 may access the execution rules 314 on the application servers 330 instead of or in addition to the execution rules 314 on the client devices 310. At least a portion of the execution rules 314 may also be located elsewhere in the experimentation system 300 so long as they can be accessed to dictate an order for executing indicated actions for experimentation, in addition to possibly also dictating other aspects of action execution.

The remote applications 332 and/or client applications 312 can provide preference levels 316, which can indicate user profile responses to actions taken by the client applications 312 and/or remote applications 332. The preference levels 316 can be computer-readable data indicating whether an action was successful or unsuccessful, possibly the extent of the success or failure (e.g., indicating that a suggested application feature was selected by user input in response to a suggestion action, and indicating an amount of time that the suggested application feature was used following the selection).

The experimentation system 300 can also include data collection servers 340. The data collection servers 340 can host external data collectors 342, which can be modules that are configured to collect external data inputs 344, which can be data inputs other than preference levels 316 or user profile information, and which can be utilized in selecting computer actions for execution. Stated another way, such external data inputs 344 can be data structures that are not directly representative of actions or characteristics of particular user profiles. For example, the external data collectors 342 may collect external data inputs 344 representing weather in particular geographic locations, traffic conditions in particular geographic locations, other events occurring in particular geographic locations, or other data inputs that can form the basis of decisions selecting follow-up actions to be performed by the client applications 312 and/or the remote applications 332.

The preference levels 316 from the client applications 312 and the remote applications 332 can be sent by the respective client applications 312 and remote applications 332 over the network 320 to the experimentation servers 350. Additionally, the external data inputs 344 can be sent from the external data collectors 342 to the experimentation servers 350.

The experimentation servers 350 can host an experimentation engine 352, which can drive the experimentation, such as by performing selections of actions to be performed. The experimentation servers 350 can also host data structures that can be accessed, modified, and used by the experimentation engine 352. For example, these data structures can include data inputs 354, such as the types of data inputs discussed above. Additionally, the experimentation servers 350 can host the selection rules 356, which can govern the selection by the experimentation engine 352 of follow-up actions to be performed using data inputs 354, such as the preference levels 316, and the external data inputs 344 from the external data collectors 342. For example, the selection rules 356 may be in the form of hard coded rules in the experimentation engine 352 and/or other types of computer-readable data such as documents (such as XML documents), tables, and/or other data structures that can be read by the experimentation engine 352.

The experimentation servers 350 may also host user profiles 358, which include data representing characteristics of particular users and/or groups of users. The user profiles 358 can be used as data input for action selections being made by the experimentation engine 352. For example, a user profile may include personal information about a represented user, such as the user's home address, work address, name, birthdate, and/or gender. Such personal information may also include data representing information about the user's employment, such as the user's profession, job title, and employer. Personal information may also include information about the user's interests and/or hobbies.

The experimentation system 300 can include measures to protect the privacy of the users represented by such user profile information. For example, the experimentation system 300 can include security measures to protect the user profile data and/or other sensitive data while such data is stored and/or while such data is being transmitted. The collection of such sensitive data may be limited to data that is needed to perform desirable functions and tasks for the users. As an example of such a limitation, personalized data may be anonymized in some situations. For example, data may be anonymized where it will only be analyzed relative to groups of user profiles, rather than being analyzed relative to an individual user profile for whom one or more actions is being selected. Additionally, the experimentation system 300 can be configured to provide notice to users whose personal information is being collected, and may gain the consent of those users to store and use data related to them. For example, the experimentation system 300 may use opt-in and/or opt-out techniques that are appropriate for particular situations.

Referring still to FIG. 3, the experimentation system 300 can also host action definitions 360. Such action definitions 360 can define actions to be taken by the client applications 312 and/or the remote applications 332. For example, the action definitions 360 may include content to be presented by the client applications 312 and/or the remote applications 332, and may also include computer-readable instructions for presenting such content. For example, the content may include graphical content, audio content, or other content that can be presented with user interface devices. The instructions may include instructions for what content to present, how to present it, and when to present it. Such action definitions 360 may be formatted in various different ways. For example, the action definitions 360 may include instructions such as links or addresses directed to other instructions and/or content to be used in taking a particular action or set of actions. The action definitions 360 may also include computer code that defines one or more operations to be performed as part of an action. The action definitions 360 may also include related data structures that can be accessed and utilized according to the instructions in the action definitions.

The action definitions 360 may interact with computer-readable instructions in the client applications 312 and/or the remote applications 332. Indeed, at least a portion of each action definition may be included in the client applications 312 and/or the remote applications 332. For example, the action definitions 360 can be simple indicators that can be recognized by the client applications 312 and/or the remote applications 332 as pointing to different content and/or instructions that are already coded into the client applications 312 and/or the remote applications 332. In other scenarios, the action definitions 360 may include audio and/or visual content and corresponding computer-readable instructions such as scripts or object code that can be fed into the client applications 312 and/or the remote applications 332 through application programming interfaces. Other scenarios may be a mixture, where some of the content and/or instructions are included in the client applications 312 and/or the remote applications 332, and some of the content and/or instructions are hosted on the experimentation servers 350 as separate action definitions 360.

The experimentation systems of FIGS. 2 and 3 have been discussed for illustrative purposes. As has been discussed above, the tools and techniques discussed herein for computer application action experimentation can be implemented in systems that are configured differently from the experimentation system 300 illustrated in FIG. 3 or the experimentation system 200 illustrated in FIG. 2. For example, the distinctions between different components illustrated in those figures may be blurred, so that functions of different illustrated components may be combined into a single computing device, program, file, document, or other data structure. Also, functions of a single component may be split into multiple components in some implementations.

### IV. Computer Application Action Experimentation Techniques

Several computer application action experimentation techniques will now be discussed. Each of these techniques and those in the following section can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable memory may have computer-executable instructions embodied thereon that, when executed by at least one processor, cause at least one processor to perform the technique. The techniques discussed below may be performed at least in part by hardware logic.

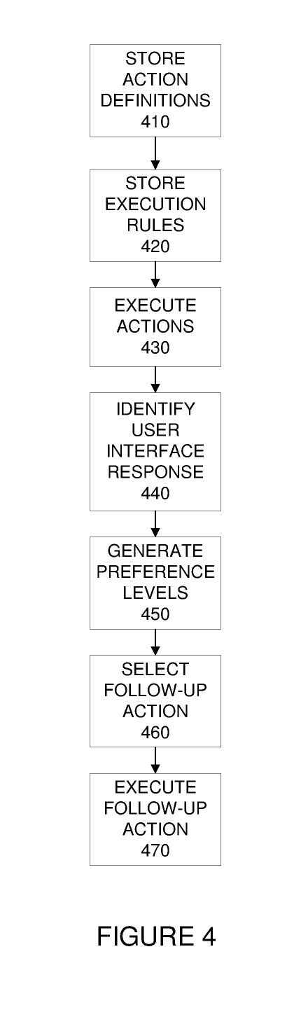

Referring to FIG. 4, a computer application action experimentation technique will be described. The technique can include storing 410 a set of pre-defined computer-readable experimentation action definitions in a computer system. Execution rules can also be stored 420 in the computer system. The execution rules can govern an execution order of the different computer actions, and the execution rules may explicitly dictate an order in which the different computer actions are to be executed. A plurality of the actions can be executed 430 with one or more computer applications, as dictated by the execution rules. The actions can be executed 430 for a current computer-readable user profile that is active in the computer system during the execution 430 of the actions. For each of the executed actions, the technique can include identifying 440 a user interface response to the execution of the action, with the user interface response being received via the computer system. The technique can further include generating 450 a set of one or more computer-readable preference levels of the current user profile, with each of the one or more preference levels being for a corresponding one of the executed actions. The generating 450 can include evaluating, via the computer system, the identified user interface responses to the executed actions.

The technique of FIG. 4 can further include selecting 460 one of the executed actions as a follow-up action to take in the computer system for a computer-readable subsequent user profile. The selecting 460 can include applying a set of computer-readable selection rules to at least one of the one or more preference levels and accounting for common characteristics between the subsequent user profile and the current user profile. The selecting 460 can include selecting the follow-up action from among a plurality of available actions, such as from the executed actions. In response to the selecting 460, the selected follow-up action can be executed 470 with a computer application for the subsequent user profile while the subsequent user profile is active in the computer system.

The common characteristics between the current user profile and the subsequent user profile may be that the current user profile and the subsequent user profile are the same user profile. Alternatively, the current user profile and the subsequent user profile may be different user profiles. In this scenario (with the profiles being different), the accounting for the common characteristics between the current user profile and the subsequent user profile can include the computer system performing a correlation operation that identifies a set of one or more common characteristics between the current user profile and the subsequent user profile, such as the two user profiles sharing the same indication of a profession or the same home city, or having usage of the same computer application, and/or some other common characteristic. The selection 460 can include selecting the follow-up action for a group of user profiles in addition to the current user profile. The group of user profiles can include the subsequent user profile and one or more other user profiles besides the current user profile. Thus, the group of user profiles can include the subsequent user profile and at least one other user profile that is not the current user profile, and the group may or may not also include the current user profile itself.

The one or more preference levels may be one or more preference levels for the current user profile, the executed actions can be executed actions for the current user profile, and the subsequent user profile can be a different user profile from the current user profile. The technique of FIG. 4 can further include executing a plurality of the different computer actions, as dictated by the execution rules, for an additional computer-readable user profile that is active in the computer system during the execution of the actions for the additional user profile. The executed actions for the additional user profile may be the same as or different from the executed actions for the current user profile. Each execution of one of the different computer actions for the additional user profile can utilize a corresponding one of the action definitions. Also, the additional user profile can be a different user profile from the current user profile and a different user profile from the subsequent user profile. The technique can further include, for each of the executed actions for the additional user profile, identifying via the computer system, a response to the execution of the action. The technique may further include generating, via the computer system, a set of one or more computer-readable preference levels of the additional user profile, with each of the one or more preference levels for the additional user profile being for a corresponding one of the executed actions for the additional user profile. The generating can include evaluating, via the computer system, the identified responses to the executed actions for the additional user profile. Also, the selecting can include applying the set of computer-readable selection rules to at least one of the one or more preference levels for the additional user profile and accounting for one or more common characteristics between the subsequent user profile and the additional user profile.

The technique of FIG. 4 may further include adding an application feature to a computer application with which the follow up action is executed in the computer system. In this case, each of the executed actions can include executing a different version of the newly-added feature. The different executed actions may each be a different user interface presentation of a user interface control that is selectable to invoke the newly-added feature of the application. The executed action may be different suggestions of a computer resource being promoted by the computer system. In this scenario, the different actions may present different offers of benefits that can be accepted by using the promoted computer resource.

The selecting 460 of the follow-up action can include applying the set of computer-readable selection rules to a plurality of preference levels generated from executing a plurality of different actions for a plurality of different user profiles including the current user profile. In this scenario, the selecting 460 can further include accounting for one or more common characteristics between the subsequent user profile and the plurality of different user profiles.

The execution rules may define a success measure. The technique can further include evaluating each of the user interface responses to determine whether the success measure is met for a corresponding action for which the user interface response is evaluated. This evaluating can include determining that the success measure is met for a successful action of the executed actions, and the selecting 460 can include selecting the successful action in response to the determining that the success measure is met. In this scenario, the current user profile and the subsequent user profile can be the same user profile. The successful action can be repeated instead of executing one or more other actions whose execution would have been dictated by the execution rules if the success measure had not been met for the successful action.

The selecting 460 of the follow-up action can include accounting for indications of preferences of one or more user profiles in the computer system. The selecting 460 can also include accounting for one or more external factors beyond indications of preferences of user profiles in the computer system.

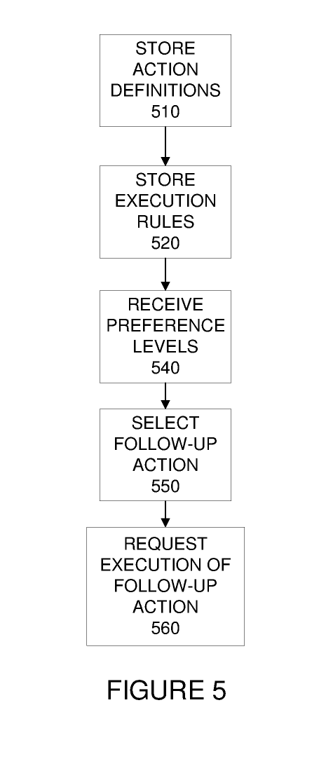

Referring now to FIG. 5, another computer application action experimentation technique will be discussed. The technique of FIG. 5 can include storing 510 experimentation action definitions in a computer system. Each of the definitions can define a different computer action. Execution rules can also be stored 520 in the computer system. The execution rules can govern an execution order of the different computer actions. A set of one or more computer-readable preference levels of a current user profile can be received 540. Each of the preference level(s) can be for a corresponding one of the executed actions being executed for the current user profile. The preference levels can correspond to user interface responses to the execution of the executed actions.

The technique of FIG. 5 can further include selecting 550 one of the executed actions as a follow-up action to take in the computer system for a subsequent user profile. The selecting 550 can include applying a set of computer-readable selection rules to at least one of the one or more preference levels. The selecting 550 can also include accounting for common characteristic(s) between the subsequent user profile and the current user profile. The selecting 550 can include selecting the follow-up action from among a plurality of available actions. In response to the selection, execution of the selected follow-up action for a subsequent user profile can be requested 560, such as by sending one or more instructions from an experimentation engine to an application.

In the technique of FIG. 5, the current user profile and the subsequent user profile can be different user profiles. In this case, the accounting for the one or more common characteristics between the current user profile and the subsequent user profile can include the computer system performing a correlation operation that identifies a set of one or more common characteristics between the current user profile and the subsequent user profile. For example, the correlation operation can include accessing and parsing the two user profiles and comparing similar fields in the user profiles.

The technique of FIG. 5 may further include adding an application feature to a computer application in the computer system, and each of the actions can include executing a different version of the feature.

The selecting 550 can include applying the set of computer-readable selection rules to a plurality of preference levels generated from executing a plurality of different actions for a plurality of different user profiles including the current user profile. The selection can further include accounting for one or more common characteristics between the subsequent user profile and the plurality of different user profiles.

The execution rules can dictate an execution order for the action definitions. The execution rules can further define a success measure, and the technique of FIG. 5 can further include evaluating each of the user interface responses to determine whether a success measure is met for a corresponding action for which the user interface response is evaluated. The evaluating can include determining that the success measure is met for a successful action of the executed actions. The technique can further include repeating the successful action for the current user profile in response to the determining that the success measure is met. The successful action may be repeated instead of executing one or more other actions whose execution would have been dictated by the execution rules if the success measure had not been met for the successful action.

Also, the techniques of FIG. 4 and/or FIG. 5 may be performed at least in part by hardware logic and/or by hardware configured by software to perform the techniques.

### V. Aspects of Certain Embodiments

Aspects of certain embodiments will now be discussed. In one such embodiment, a computer system can include means for storing a set of pre-defined computer-readable experimentation action definitions in the computer system, with each of the action definitions defining a different computer application action. The computer system can also include means for storing execution rules in the computer system, with the execution rules governing an execution order of the different computer actions. For example, such storing may be in one or more data structures in a storage device such as those discussed above, such as in one or more databases.

The computer system can also include means for executing a plurality of the different computer actions, as dictated by the execution rules, for a current computer-readable user profile that is active in the computer system during the execution of the actions, with each execution of one of the different computer actions utilizing a corresponding one of the action definitions. For example, this executing of actions, as well as other executing of actions discussed herein may be performed via one or more physical processors, which may also be running software to configure the computer system in the execution of the actions. The computer system can also include means for identifying via the computer system, for each of the executed actions, a response to the execution of the action, such as by identifying a user input response provided through an input device, such as those discussed above. Moreover, the computer system can include means for generating a set of one or more computer-readable preference levels of the current user profile, with each of the one or more preference levels being for a corresponding one of the executed actions, and with the generating including evaluating, via the computer system, the identified responses to the executed actions. Such generating can be performed via one or more processors that can process the identified responses via one or more computer processors according to stored computer-readable instructions, such as by categorizing the identified responses according to pre-defined categories corresponding to the preference levels.

Additionally, the computer system can include means for selecting one of the executed actions as a follow-up action to take in the computer system for a computer-readable subsequent user profile, with the selecting including applying a set of computer-readable selection rules to at least one of the one or more preference levels and accounting for one or more common characteristics between the subsequent user profile and the current user profile, and the selecting including selecting the follow-up action from among a plurality of available actions. For example, such selection may include one or more processors performing one or more computations on computer-readable stored preference levels according to the computer-readable selection rules, such as performing mathematical computations to combine various factors to score one or more available actions, and comparing the scores for the actions.

The computer system can also include means for executing, in response to the selecting, the selected follow-up action with a computer application for the subsequent user profile while the subsequent user profile is active in the computer system.

In this aspect, the current user profile and the subsequent user profile can be different user profiles, and accounting for the one or more common characteristics between the current user profile and the subsequent user profile can include performing a correlation operation that identifies a set of one or more common characteristics between the current user profile and the subsequent user profile. Also, the selecting can include selecting the follow-up action for a group of multiple user profiles, where the group of user profiles can include the subsequent user profile and one or more other user profiles besides the current user profile. Also, all the users in the group of multiple users can have the set of one or more common characteristics.

Also, the one or more common characteristics between the current user profile and the subsequent user profile can indicate that the current user profile and the subsequent user profile are the same user profile. Moreover, each of the actions can include presenting a different user interface presentation of a user interface control that is selectable to invoke a feature of the computer application. Also, the selecting of the follow-up action can include applying the set of computer-readable selection rules to a plurality of preference levels generated from executing a plurality of different actions for a plurality of different user profiles including the current user profile, and the selecting can further include accounting for one or more common characteristics between the subsequent user profile and the plurality of different user profiles.

The identified responses can be user interface responses received via the computer system, wherein the execution rules can further define a success measure. The computer system can further include means for evaluating each of the user interface responses (such as via a computer processor performing computations on the responses using stored computer-readable instructions) to determine whether the success measure is met for a corresponding action for which the user interface response is evaluated. The evaluating can include determining that the success measure is met for a successful action of the executed actions, where the selecting includes selecting the successful action in response to the determining that the success measure is met, where the current user profile and the subsequent user profile are the same user profile, and where execution of the selected follow-up action includes repeating the successful action instead of executing one or more other actions whose execution would have been dictated by the execution rules if the success measure had not been met for the successful action.

The selecting of the follow-up action in this aspect can include accounting for indications of preferences of one or more user profiles including the current user profile, and accounting for one or more external factors beyond indications of preferences of user profiles in the computer system.

According to another aspect of certain embodiments, a set of computer-readable experimentation action definitions can be stored in a computer system, with each of the action definitions defining a different computer action. Execution rules can be stored in the computer system, with the execution rules governing an execution order of the different computer actions. A set of one or more computer-readable preference levels of a current user profile can be received, with each of the one or more preference levels being for a corresponding one of the executed actions being executed for the current user profile, with the preference levels corresponding to user interface responses to the execution of the executed actions.

One of the executed actions can be selected as a follow-up action to take in the computer system for a subsequent user profile, with the selecting including applying a set of computer-readable selection rules to at least one of the one or more preference levels and accounting for one or more common characteristics between the subsequent user profile and the current user profile, and the selecting including selecting the follow-up action from among a plurality of available actions. Execution of the selected follow-up action for the subsequent user profile can be requested in response to the selecting.

According to another aspect of certain embodiments, a set of computer-readable experimentation action definitions can be stored in a computer system, with each of the action definitions defining a different computer action. Execution rules can be stored in the computer system, with the execution rules governing an execution order of the different computer actions. An indication of execution can be received, where the indication of execution indicates execution of a plurality of the different computer actions as dictated by the execution rules for a current user profile that is active during the execution of the actions, with each execution of one of the different computer actions utilizing a corresponding one of the action definitions. An identification of a user interface response to the execution action can be received for each of the executed actions.

Also in this aspect, a set of one or more computer-readable preference levels of the user profile can be received, with each of the one or more preference levels being for a corresponding one of the executed actions, with the preference levels corresponding to the user interface responses to the execution of the actions. One of the executed actions can be selected as a follow-up action to take in the computer system for a subsequent user profile. The selecting can include applying a set of computer-readable selection rules to at least one of the one or more preference levels and accounting for one or more common characteristics between the subsequent user profile and the current user profile, and the selecting can include selecting the follow-up action from among a plurality of available actions. In response to the selecting, performance of the selected follow-up action for the subsequent user profile can be requested via the computer system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A computer system comprising:
at least one processor; and
memory comprising instructions stored thereon that when executed by at least one processor cause at least one processor to perform computer action experimentation acts comprising:
storing a set of pre-defined computer-readable experimentation action definitions in the computer system, with each of the action definitions defining a different computer application action;
storing execution rules in the computer system, with the execution rules governing an execution order of the different computer actions;
executing, via the computer system, a plurality of the different computer actions, as dictated by the execution rules, for a current computer-readable user profile that is active in the computer system during the execution of the actions, with each execution of one of the different computer actions utilizing a corresponding one of the action definitions;
for each of the executed actions, identifying via the computer system, a response to the execution of the action;
generating, via the computer system, a set of one or more computer-readable preference levels of the current user profile, with each of the one or more preference levels being for a corresponding one of the executed actions, the generating comprising evaluating, via the computer system, the identified responses to the executed actions;
selecting, via the computer system, one of the executed actions as a follow-up action to take in the computer system for a computer-readable subsequent user profile, with the selecting comprising applying a set of computer-readable selection rules to at least one of the one or more preference levels and accounting for one or more common characteristics between the subsequent user profile and the current user profile, and the selecting comprising selecting the follow-up action from among a plurality of available actions; and
in response to the selecting, executing via the computer system, the selected follow-up action with a computer application for the subsequent user profile while the subsequent user profile is active in the computer system.

2. The computer system of claim 1, wherein the current user profile and the subsequent user profile are different user profiles, and wherein accounting for the one or more common characteristics between the current user profile and the subsequent user profile comprises the computer system performing a correlation operation that identifies a set of one or more common characteristics between the current user profile and the subsequent user profile.

3. The computer system of claim 2, wherein the selecting comprises selecting the follow-up action for a group of multiple user profiles, wherein the group of user profiles comprises the subsequent user profile and one or more other user profiles besides the current user profile, and wherein all the users in the group of multiple users have the set of one or more common characteristics.

4. The computer system of claim 1, wherein:
the one or more preference levels are one or more preference levels for the current user profile;
the executed actions are executed actions for the current user profile;
the subsequent user profile is a different user profile from the current user profile;
the acts further comprise:
executing, via the computer system, a plurality of the different computer actions, as dictated by the execution rules, for an additional computer-readable user profile that is active in the computer system during the execution of the actions for the additional user profile, with each execution of one of the different computer actions for the additional user profile utilizing a corresponding one of the action definitions, and with the additional user profile being a different user profile from the current user profile and a different user profile from the subsequent user profile;
for each of the executed actions for the additional user profile, identifying via the computer system, a response to the execution of the action; and
generating, via the computer system, a set of one or more computer-readable preference levels of the additional user profile, with each of the one or more preference levels for the additional user profile being for a corresponding one of the executed actions for the additional user profile, with the generating of the set of one or more preference levels of the additional user profile comprising evaluating, via the computer system, the identified responses to the executed actions for the additional user profile; and
the selecting comprises applying the set of computer-readable selection rules to at least one of the one or more preference levels for the additional user profile and accounting for one or more common characteristics between the subsequent user profile and the additional user profile.

5. The computer system of claim 1, wherein the one or more common characteristics between the current user profile and the subsequent user profile indicate that the current user profile and the subsequent user profile are the same user profile.

6. The computer system of claim 1, wherein each of the executed actions comprises executing a different version of a feature of the application.

7. The computer system of claim 1, wherein the acts further comprise adding an application feature to the computer application, and wherein each of the actions comprises presenting a different user interface presentation of a user interface control that is selectable to invoke the feature of the application.

8. The computer system of claim 1, wherein the executed actions are different suggestions of a computer resource being promoted by the computer system.

9. The computer system of claim 1, wherein the selecting of the follow-up action comprises applying the set of computer-readable selection rules to a plurality of preference levels generated from executing a plurality of different actions for a plurality of different user profiles comprising the current user profile, and wherein the selecting further comprises accounting for one or more common characteristics between the subsequent user profile and the plurality of different user profiles.

10. The computer system of claim 1, wherein the identified responses are user interface responses received via the computer system.

11. The computer system of claim 10, wherein the execution rules further define a success measure, wherein the acts further comprise evaluating each of the user interface responses to determine whether the success measure is met for a corresponding action for which the user interface response is evaluated, wherein the evaluating comprises determining that the success measure is met for a successful action of the executed actions, wherein the selecting comprises selecting the successful action in response to the determining that the success measure is met, and wherein the current user profile and the subsequent user profile are the same user profile.

12. The computer system of claim 11, wherein the successful action is repeated instead of executing one or more other actions whose execution would have been dictated by the execution rules if the success measure had not been met for the successful action.

13. The computer system of claim 1, wherein the selecting of the follow-up action comprises accounting for indications of preferences of one or more user profiles including the current user profile, and accounting for one or more external factors beyond indications of preferences of user profiles in the computer system.

14. A computer-implemented method, comprising:
storing a set of computer-readable experimentation action definitions in a computer system, each of the action definitions defining a different computer action;
storing execution rules in the computer system, the execution rules governing an execution order of the different computer actions;
receiving a set of one or more computer-readable preference levels of a current user profile, with each of the one or more preference levels being for a corresponding one of the executed actions being executed for the current user profile, with the preference levels corresponding to user interface responses to the execution of the executed actions;
selecting, via the computer system, one of the executed actions as a follow-up action to take in the computer system for a subsequent user profile, with the selecting comprising applying a set of computer-readable selection rules to at least one of the one or more preference levels and accounting for one or more common characteristics between the subsequent user profile and the current user profile, and the selecting comprising selecting the follow-up action from among a plurality of available actions; and
in response to the selecting, requesting via the computer system, execution of the selected follow-up action for the subsequent user profile.

15. The method of claim 14, wherein the current user profile and the subsequent user profile are different user profiles, and wherein accounting for the one or more common characteristics between the current user profile and the subsequent user profile comprises the computer system performing a correlation operation that identifies a set of one or more common characteristics between the current user profile and the subsequent user profile.

16. The method of claim 14, further comprising adding an application feature to a computer application in the computer system, wherein each of the executed actions comprises executing a different version of the feature.

17. The method of claim 14, further comprising wherein the selecting comprises applying the set of computer-readable selection rules to a plurality of preference levels generated from executing a plurality of different actions for a plurality of different user profiles comprising the current user profile, and wherein the selecting further comprises accounting for one or more common characteristics between the subsequent user profile and the plurality of different user profiles.

18. The method of claim 14, wherein the execution rules dictate an execution order for the action definitions, wherein the execution rules further define a success measure, wherein the method further comprise evaluating each of the user interface responses to determine whether success measure is met for a corresponding action for which the user interface response is evaluated, wherein the evaluating comprises determining that the success measure is met for a successful action of the executed actions, and wherein the method further comprises repeating the successful action for the current user profile in response to the determining that the success measure is met.

19. The method of claim 18, wherein the successful action is repeated instead of executing one or more other actions whose execution would have been dictated by the execution rules if the success measure had not been met for the successful action.

20. One or more computer-readable memory having computer-executable instructions embodied thereon that, when executed by at least one processor, cause at least one processor to perform acts comprising:
storing a set of computer-readable experimentation action definitions in a computer system, each of the action definitions defining a different computer action;
storing execution rules in the computer system, the execution rules governing an execution order of the different computer actions;
receiving an indication of execution of a plurality of the different computer actions as dictated by the execution rules for a current user profile that is active during the execution of the actions, with each execution of one of the different computer actions utilizing a corresponding one of the action definitions;
for each of the executed actions, receiving an identification of a user interface response to the execution of the action;
receiving a set of one or more computer-readable preference levels of the user profile, with each of the one or more preference levels being for a corresponding one of the executed actions, with the preference levels corresponding to the user interface responses to the execution of the actions;
selecting, via the computer system, one of the executed actions as a follow-up action to take in the computer system for a subsequent user profile, with the selecting comprising applying a set of computer-readable selection rules to at least one of the one or more preference levels and accounting for one or more common characteristics between the subsequent user profile and the current user profile, and the selecting comprising selecting the follow-up action from among a plurality of available actions; and
in response to the selecting, requesting via the computer system, performance of the selected follow-up action for the subsequent user profile.
